(19) United States
(12) Patent Application Publication
(10) Pub. No.: US 2026/0061335 A1
(43) Pub. Date: Mar. 5, 2026

(54) REFLECTIVE TRAFFIC SIGNS FOR SCALE MODELS

(71) Applicant: Trent Botting, New Westminster (CA)

(72) Inventor: Trent Botting, New Westminster (CA)

(21) Appl. No.: 19/284,497

(22) Filed: Jul. 29, 2025

(30) Foreign Application Priority Data
Aug. 6, 2024 (CA) 3251036

(51) Int. Cl. A63H 33/42; B33Y 80/00

(52) U.S. Cl. CPC A63H 33/42; B33Y 80/00

(57) ABSTRACT

A method and system for fabricating reflective traffic signs for scale model applications. A scaled traffic sign image is generated using graphic design software and printed onto a transparent or reflective medium. The printed signage layer is bonded to a reflective substrate and affixed to a rigid backing material such as aluminum. The sign is then mounted on a scale stand formed from metal, plastic, or wood. Various fabrication techniques may be used, including water transfer of printed images using clear tape, printing onto acetate, or direct printing onto reflective material. In some embodiments, 3D-printed structural supports are used to house light-emitting diodes (LEDs) to simulate illuminated signage. The resulting scale signs replicate the appearance and reflective characteristics of full-size traffic signs and are suitable for use in model railroads, dioramas, architectural layouts, and educational displays.

### BACKGROUND OF THE INVENTION

The field of the invention relates generally to scale modeling, and more particularly to methods and systems for fabricating reflective traffic signs suitable for use in scale model environments such as model railroads, architectural dioramas, and miniature vehicular scenes.

In the scale modeling domain, traffic signage contributes to environmental realism and authenticity. Existing model signs are typically fabricated from thick, opaque plastic and lack reflective properties, which reduces realism in illuminated or detailed scenes. While reflective materials exist in other industries, no widely adopted or standardized method for producing scale-accurate, reflective traffic signs is known within the modeling community. Current methods are often manual, inconsistent, and fail to combine scalability, reflectivity, and realism.

Therefore, there exists a need for a repeatable, efficient method of producing reflective traffic signs for scale models. The present invention addresses this need through the integration of reflective films, rigid backings, printed overlays, and optional lighting and structural elements, resulting in signs that more accurately replicate full-scale traffic signage in miniature form.

### SUMMARY OF THE INVENTION

The present invention provides a method and system for constructing reflective traffic signs intended for use in scale model environments. The method includes the creation of a multi-layered sign assembly comprising a printed signage layer, a reflective layer, and a rigid backing such as aluminum. The signs may be fabricated using various techniques, including water transfer, acetate overlay, or direct printing.

Each sign is mounted on a scaled stand formed of plastic, wood, or metal, which may further include simulated mounting brackets. An advanced embodiment integrates 3D-printed structural supports with embedded LED lighting, enabling the simulation of illuminated road signs.

The invention addresses the lack of standardized, reproducible methods for creating reflective scale signage and offers an adaptable fabrication approach suitable for hobbyists, educators, and professionals working with model-scale infrastructure.

### BRIEF DESCRIPTION OF DRAWINGS

FIG. 1 represents two interchangeable translucent materials used for the forepart layer of alternate embodiments 1 and 2. The translucent material in the first embodiment is clear tape; in the second embodiment, acetate.

FIG. 2 represents the double-sided tape layer.

FIG. 3 represents the reflective layer that reflects light through the translucent printed image.

FIG. 4 represents the metallic layer that adheres to the back of the first two combined layers.

FIG. 5 shows the sign stand comprising a short rod, intended to demonstrate how the brackets and base are aligned.

FIG. 6 depicts two tubular beads forming clamps that fit onto the rod to support the sign and form the base. The rod is cut below the base at half the length of the stand for ground insertion and vertical support.

FIG. 7 is an orthographic projection of a complex sign structure intended for 3D printing.

FIG. 8 is an isometric projection of a complex sign structure intended for 3D printing.

FIG. 9 represents an LED and LED housing with a wiring scheme, where black indicates the negative terminal and white the positive.

FIG. 10 represents the internal wiring configuration, again using black for negative and white for positive.

FIG. 11 represents a resistor component within the circuit.

FIG. 12 represents the power supply component.

FIG. 13 represents the printed sign structure bonded to the back of the sign body.

### Brief Description of Photographs

### Digital Construction Process

FIG. 14 illustrates the initialization of the digital workspace. The canvas is configured to a resolution of no less than 300 dots per inch (DPI) on a standard 8.5×11-inch document size, suitable for high-quality printing.

FIG. 15 shows a scanned scale ruler imported into a digital editing environment (e.g., Adobe Photoshop), positioned both vertically and horizontally to serve as a reference for accurate alignment and scaling.

FIG. 16 depicts the process of sourcing and preparing signage. A road sign image is selected from the official driver's manual, copied into the digital workspace, and cleaned of background noise. The sign is aligned using rulers, scaled according to official dimensions (e.g., 2′2″×2′2″), and all color is removed, leaving only black elements for printing onto paper.

### Physical Construction of the Sign Body

### First Alternate Embodiment—Clear Tape Transfer (Water Transfer Method)

FIG. 17 shows the initial preparation of the printed sign. The sign is cut out and placed face-up on the work surface, and a piece of clear tape is applied over the printed surface for transfer.

FIG. 18 depicts burnishing the clear tape onto the sign using a finger, followed by a smooth, hard object (e.g., scissor handle), working from the center outward to prevent wrinkles.

FIG. 19 shows trimming of the sign to remove any excess tape from the reverse side.

FIG. 20 illustrates soaking the taped sign in water for approximately five minutes to loosen the paper backing.

FIG. 21 depicts the removal of the paper backing. The sign is placed face down and the wet paper is gently rubbed off, leaving the ink transferred onto the clear tape.

FIG. 22 shows the trimmed tape sign aligned and applied to the reflective material, which adheres naturally without glue.

FIG. 23 illustrates the final adherence step. The reflective tape sign is mounted onto an aluminum surface, and all layers are pressed firmly together.

FIG. 24 depicts the final trimming of the assembled sign, resulting in clean edges and accurately finished dimensions.

### Second Alternate Embodiment—Use of Acetate with Double-Sided Tape

FIG. 25 illustrates the preparation of the forepart layer. The signage is printed directly onto clear acetate, bonded to the reflective surface using clear double-sided tape, and mounted onto an aluminum backing. This completes the layered structure as shown in FIG. 23, followed by final trimming as shown in FIG. 24.

### Construction of Shaft and Brackets of the Stand

### First Embodiment—Metal Shaft with Tubular Brackets

FIG. 26 illustrates construction of a simple sign stand using scale piano wire. The wire is cut to provide a visible shaft and an extended portion for insertion into the ground.

FIG. 27 depicts the use of tubular beads, made of either metal or plastic, to form brackets for mounting the sign onto the wire shaft.

FIG. 28 shows the bottom end of the wire shaft cut at an angle to facilitate easier insertion into the ground.

FIG. 29 illustrates the final assembly, with the stand and brackets affixed to the back of the sign body using adhesive, and the completed sign inserted into a model ground display.

### Second Embodiment—Stand Made from Scale Lumber or Plastic

FIG. 30 depicts an alternative construction of a simple sign stand using scale lumber or plastic components, painted white to simulate the appearance of a realistic sign support structure.

FIG. 31 shows the application of adhesive to the stand constructed in FIG. 30, preparing it for attachment to the rear of the sign body.

FIG. 32 illustrates the final assembled sign, with the stand from FIGS. 30 and 31 secured to the back of the sign body using adhesive.

### DETAILED DESCRIPTION OF THE INVENTION

### Step 1—Digital Construction of Signage

An adaptable technique using digital graphics software to produce various scaled signage suitable for multiple embodiments of the invention. This process includes two main stages illustrated by photographs:

### Stage 1—Digital Workspace Setup

The preparation of the digital workspace establishes a resolution of at least 300 DPI on an 8.5″×11″ canvas to enable high-quality printing, as illustrated in FIG. 14.

In FIG. 15, a scanned scale ruler is imported into the digital editing software (e.g., Adobe Photoshop) and positioned vertically and horizontally using the “Free Transform” tool. The imported rulers are aligned along the X and Y axes to enable accurate measurement and scaling. Extraneous portions of the ruler graphics are removed, and the workspace is finalized by cleaning up the background area.

### Stage 2—Construction of Scaled Digital Signage

As depicted in FIG. 16, a road sign image is sourced from an official driver's manual. The sign is extracted, cleaned of background “noise,” and pasted into the digital workspace. Using the scale rulers, the image is resized to a given scale, proportionate to official dimensions (e.g., 2′2″×2′2″). The color of the sign is removed (e.g., yellow) using selection tools, leaving only the black elements necessary for printing. The sign is then repositioned within the canvas in preparation for printing.

### Step 2—Physical Construction of the Sign Body

Three alternate embodiments for constructing the physical sign body are described and depicted in the drawings and photographs. Each utilizes the printed digital signage created in Step 1, affixed to various layers including reflective materials and aluminum backings.

### First Alternate Embodiment—Clear Tape Transfer (Water Transfer Method)

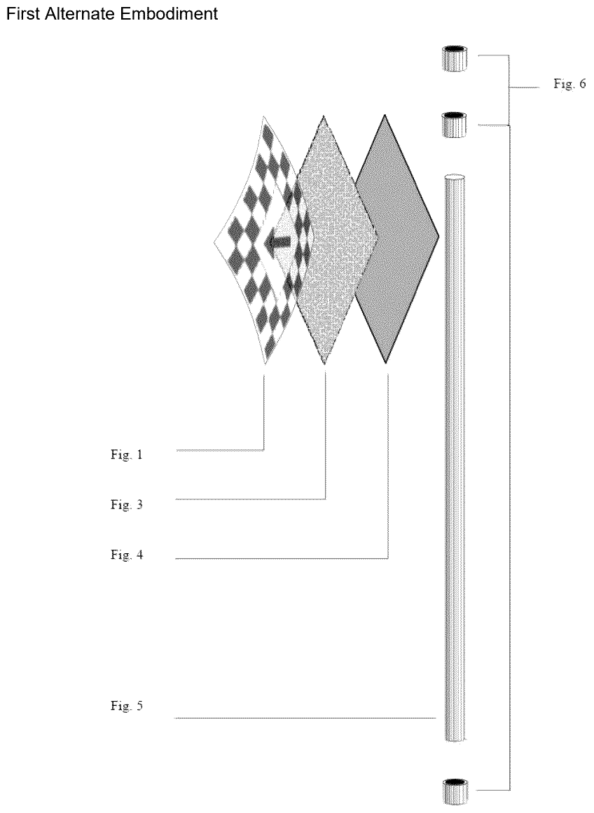

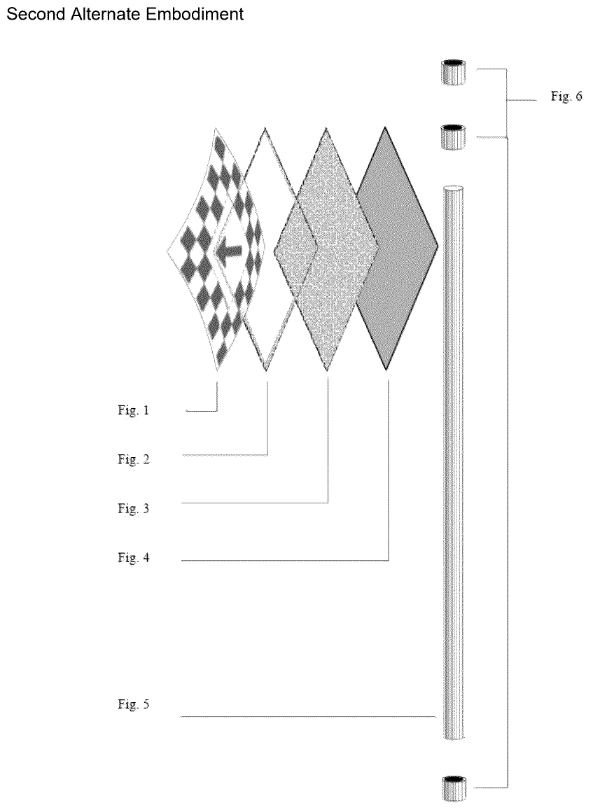

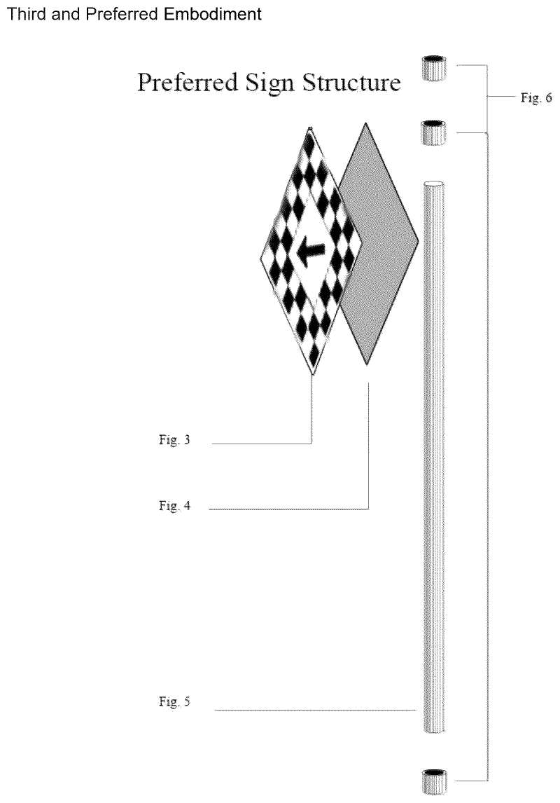

Referring to the accompanying figures, the first embodiment of the invention comprises of a method for forming a forepart layer of a signage assembly through a clear tape-based water transfer process. As illustrated in the drawings, the method involves transferring printed signage from paper onto a clear adhesive tape (FIG. 1), followed by application onto a reflective layer (FIG. 3) and an aluminum backing (FIG. 4). The method comprises the following sequential steps, further illustrated in FIGS. 17 to 24:

Tools and materials utilized in this embodiment include:
Clear adhesive tape (transparent)
Printed signage on paper
Reflective material
Aluminum material
Bowl of water
Scissors

FIG. 17 A printed sign is cut from paper and placed face-up on a flat working surface. A section of clear adhesive tape is cut to a suitable size and held with both hands to form a concave curve, allowing for even placement.

FIG. 18 The clear tape is carefully applied over the printed surface of the signage. Initial adhesion is secured using a fingertip, followed by firm burnishing with a hard, smooth object (e.g., the handle of scissors), beginning from the center and moving outward to eliminate wrinkles and air bubbles.

FIG. 19 Care is taken to avoid contact between the adhesive side of the tape and the back of the paper sign. The taped sign is then trimmed as needed.

FIG. 20 The taped signage is submerged in water for approximately five (5) minutes to saturate the paper backing.

FIG. 21 Once soaked, the taped sign is removed and placed face-down, with the paper side up. The wet paper backing is gently rolled off, leaving the ink or printed content transferred and embedded onto the clear tape.

FIG. 22 The resulting transparent tape sign is aligned with and applied to a reflective layer. Adhesion occurs naturally without the need for additional adhesive substances due to the residual glue and inherent tackiness of the tape.

FIG. 23 The reflective-tape sign assembly is then adhered to an aluminum backing layer. The three layers (signage on clear tape, reflective and aluminum materials) are pressed firmly to ensure full bonding.

FIG. 24 The final composite sign is trimmed to achieve clean edges and precise, finished dimensions.

### Second Alternate Embodiment—Use of Acetate With Double-sided Tape

Referring to the accompanying figures, the second alternate embodiment utilizes clear acetate as the forepart layer of the sign body (FIG. 1), printed directly with the signage image and bonded using clear double-sided tape (FIG. 2) to the reflective layer (FIG. 3) and subsequently mounted onto the aluminum backing (FIG. 4).

The process as depicted in the photographs is as follows:

Tools and materials utilized in this embodiment include:
Clear acetate sheet
Clear double-sided tape (thin)
Reflective material
Aluminum material
Scissors or cutting tool

FIG. 25 The signage is printed directly onto the clear acetate. The reflective layer is prepared by applying clear double-sided tape across its surface. As previously shown in FIGS. 22 to 24, the printed acetate sheet is carefully aligned and affixed to the reflective surface, then the layered structure is mounted onto the aluminum backing layer. The final composite sign is trimmed to achieve clean edges and precise, finished dimensions.

### Third and Preferred Embodiment—Direct Print Onto Reflective Layer.

Referring to the accompanying figures, In the third and preferred embodiment, the forepart layer of the sign body consists of direct printing onto the reflective material (FIG. 3), which is then affixed to the aluminum backing (FIG. 4). This embodiment eliminates the need for an additional clear medium and provides a streamlined construction process that ensures durability and visual clarity. This embodiment is considered preferred due to its efficiency, reduced materials, and enhanced visual sharpness.

Finally, each of the three embodiments (tape transfer, acetate bonding, and direct print) may optionally undergo lamination as a final step to protect the signage and increase longevity.

### Step 3—Construction of the Sign Stands and Brackets

Multiple embodiments for constructing the support stands for the scale signs are presented and illustrated in the accompanying drawings and photographs.

Some signs will have flat bottoms as free-standing signs to be placed beside models that do not have a dioramic setting, for example, a car sitting on a glass shelf in a glass face cabinet.

Tools and materials needed for physically constructing the shaft of the stands and brackets includes:
Metal wire, plastic rods, or wood (for shaft)
Metal, plastic, or glass beads (for brackets)
Wire cutters or pliers
Super glue or equivalent adhesive
Paint (for finishing, if desired)

### First Embodiment—Metal Shaft with Tubular Brackets

Referring to the accompanying figures, a scale metal shaft (FIG. 5) is inserted into the plurality of beads made of metal, plastic, or glass to simulate mounting brackets and a base (FIG. 6) to form a stand. The stand is to be affixed to the back aluminum layer of the sign body (FIG. 4).

The process as depicted in the photographs is as follows:

FIG. 26 Piano wire is cut to size, including extra length for insertion into the ground.

FIG. 27 Tubular beads are selected to simulate brackets and positioned along the shafts.

FIG. 28 The bottom of the shaft is cut at an angle for ease of ground insertion.

FIG. 29 Illustrates the final assembly, with the stand and brackets affixed to the back of the sign body using adhesive, and the completed sign inserted into a model ground display.

### Second Embodiment—Stand Made From Scale Lumber or Plastic

Referring to the accompanying figures, a painted scale lumber or plastic shaft of the stand (FIG. 5) is to be affixed directly to the back of the aluminum layer (FIG. 4).

The process as depicted in the photographs is as follows:

FIG. 30 The shaft is constructed using wood or plastic painted white to simulate realistic signposts.

FIG. 31 Adhesive is applied to one side of the shaft.

FIG. 32 The shaft is then affixed to the center back of the assembled sign body.

### Third Embodiment—Electrified Stand with 3D Printed Structural Supports and LEDs

This embodiment represents a more advanced construction designed to simulate real-life illuminated road signs, such as those on cantilevers and bridges. It involves 3D-printed structural elements and integrated LED lighting.

This embodiment is particularly suitable for educational demonstrations, architectural dioramas, and scaled-down smart infrastructure prototypes.

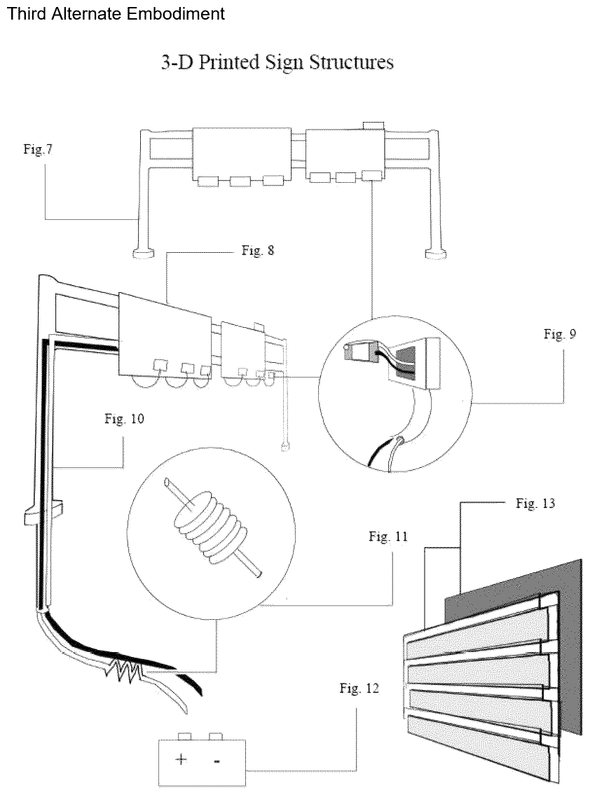

Key Components:
3D printed sign structures (FIGS. 7 and 8)
LED lights and housing (FIG. 9)
Wiring scheme black and white (FIG. 10)
Resistor (FIG. 11)
Power supply (FIG. 12)

FIGS. 7 and 8 Exemplify the 3D printed signs structures.

FIG. 9 LEDs are inserted into their housings and mounted at appropriate positions on the 3D-printed sign frame.

FIG. 10 Wiring (black for negative and white for positive) is routed internally through the hollow legs of the printed structure.

FIG. 11 A resistor is installed in-line to ensure safe voltage levels for the LEDs.

FIG. 12 The wiring connects to an external or integrated power supply.

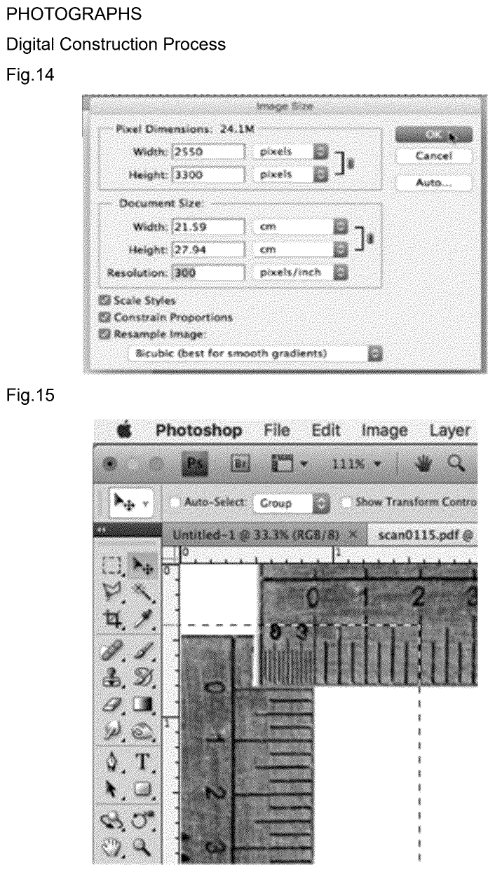

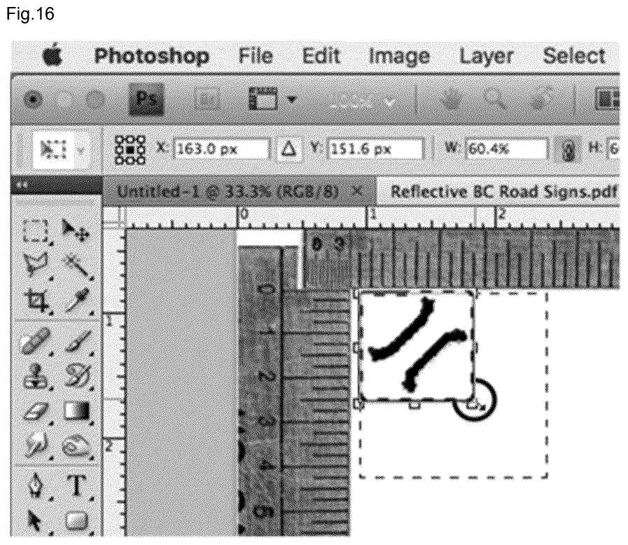

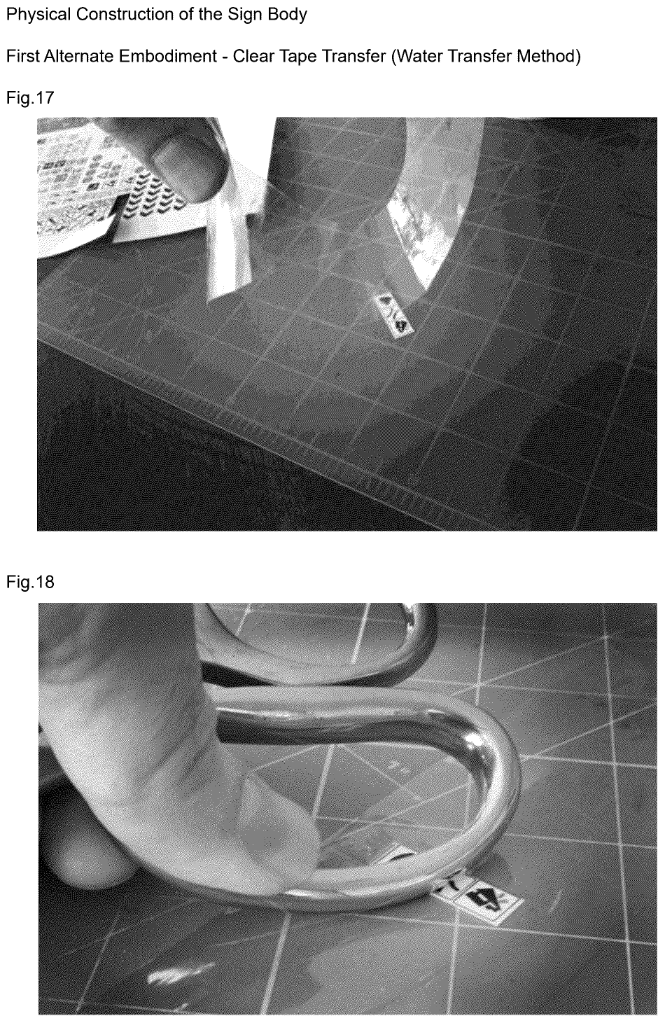

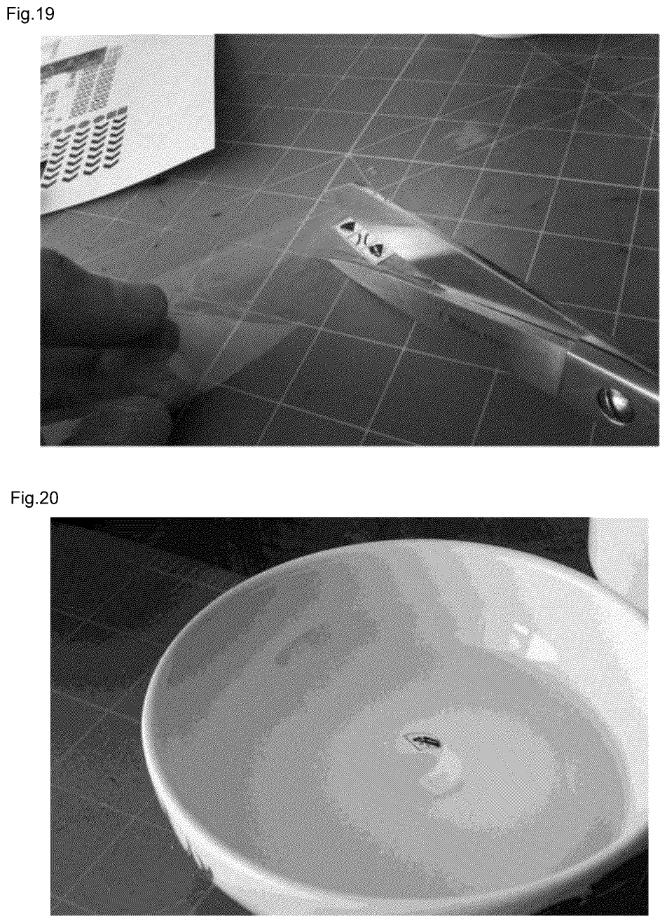

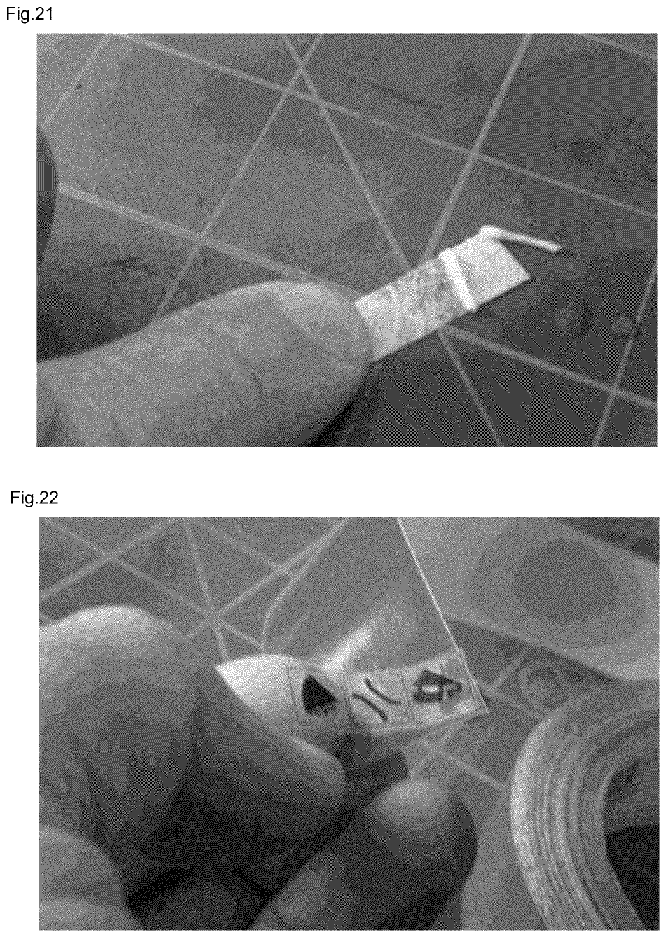

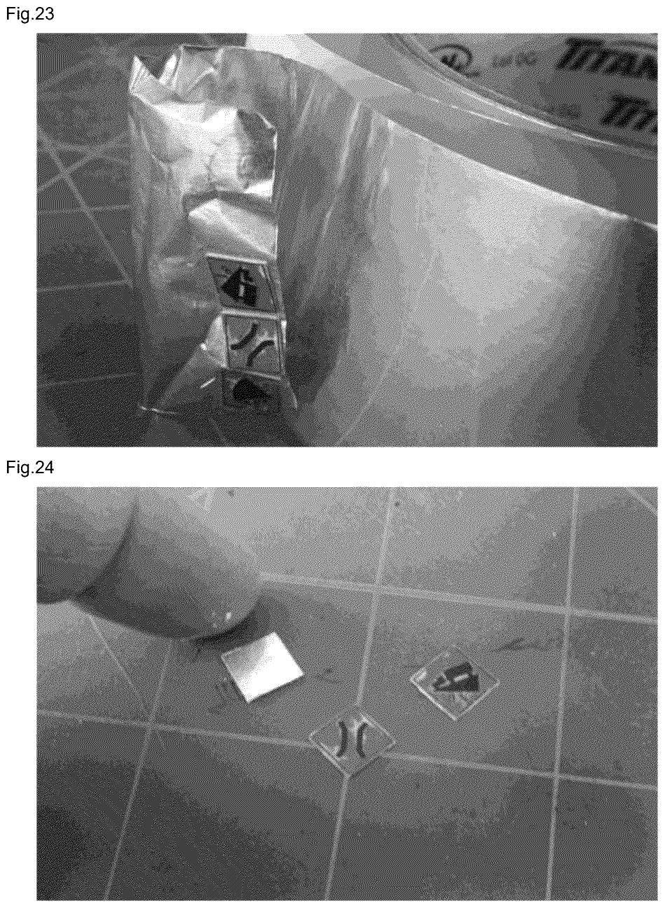

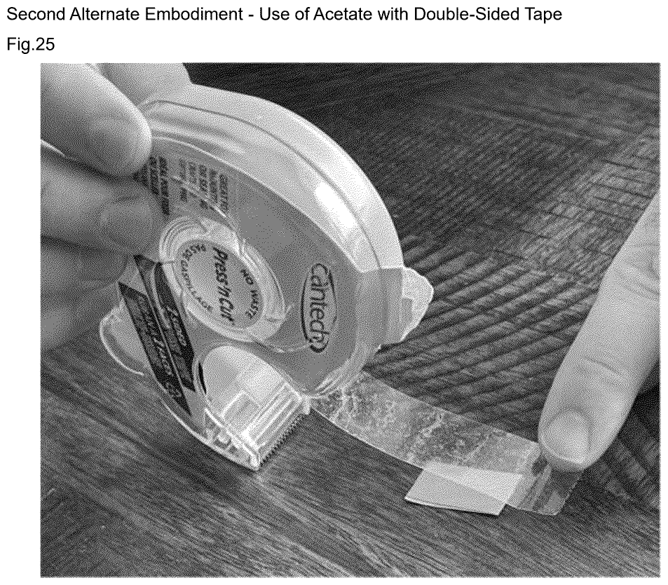

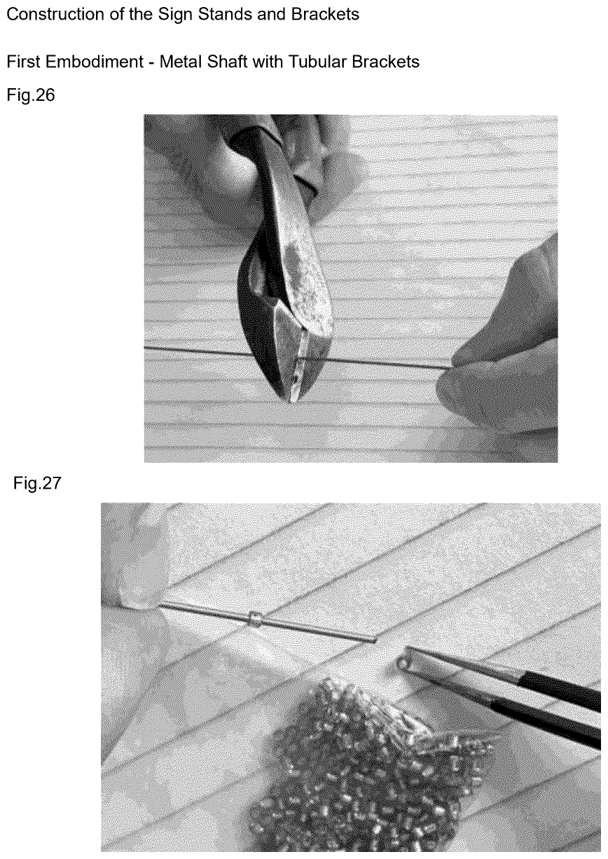

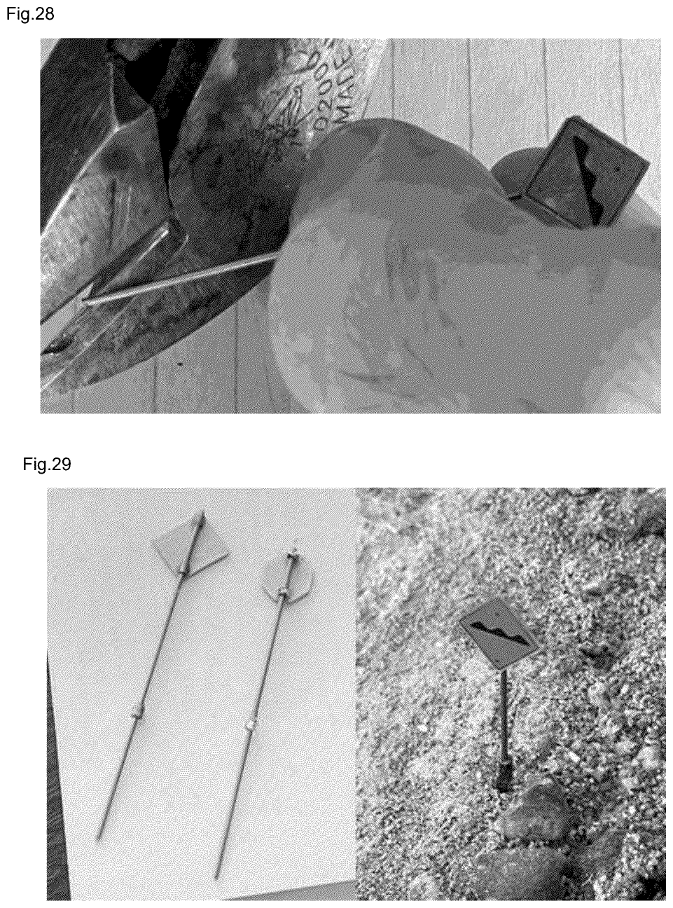

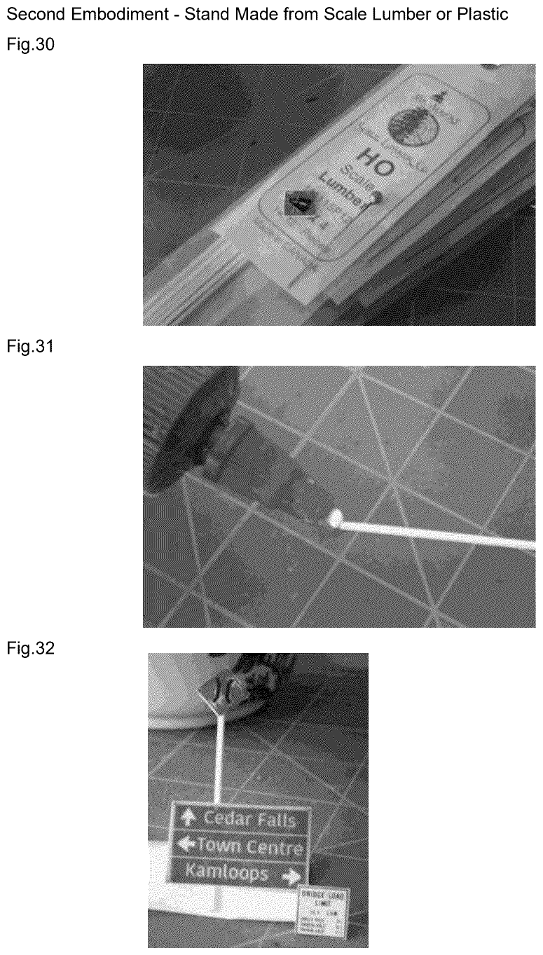

FIG. 13 The printed sign structure is bonded to the back of the sign body.

The Embodiments of the Invention in which an exclusive property of privilege is claimed are defined as follows:

1. A method for fabricating a reflective traffic sign for use in scale models, comprising:
producing a scaled traffic sign image using digital graphic design software;
printing the scaled image onto a transparent or reflective medium to form a signage layer;
bonding the signage layer to a reflective layer;
affixing the reflective layer to a rigid backing layer comprising aluminum; and
attaching a scale stand to the backing layer, the stand comprising a shaft formed from plastic, metal, or wood.

2. The method of claim 1, wherein the signage layer is formed by transferring printed ink from paper onto clear adhesive tape, soaking the tape in water to remove the paper backing, and applying the tape to the reflective layer.

3. The method of claim 1, wherein the signage layer comprises clear acetate printed with the scaled image and bonded to the reflective layer using clear double-sided adhesive tape.

4. The method of claim 1, wherein the signage layer comprises a direct print of the scaled image onto the reflective layer.

5. The method of claim 1, further comprising applying a transparent laminate over the signage layer to increase durability.

6. The method of claim 1, further comprising attaching one or more light-emitting diodes (LEDs) to the sign assembly, the LEDs housed within a 3D-printed or resin-printed structure configured to support the sign and conceal wiring.

7. The method of claim 1, wherein the stand further comprises a plurality of beads positioned along the shaft to simulate mounting brackets and a base.

8. The method of claim 6, wherein the 3D-printed structure includes internal channels for routing electrical wiring and supports an external or embedded power supply.

9. The method of claim 1, wherein the traffic sign image corresponds to a road sign from a selected country, enabling the production of reflective signs for international scale model themes.
